(19) United States
(12) Patent Application Publication
(10) Pub. No.: US 2026/0054360 A1
(43) Pub. Date: Feb. 26, 2026

(54) A DEVICE FOR POSITIONING A SERIES OF FASTENERS IN FRONT OF A DRIVER, AND RELATED METHODS AND COMPONENTS

(71) Applicant: Sigurdur Ottar Hreinsson, Seltjarnarnes (IS)

(72) Inventor: Sigurdur Ottar Hreinsson, Seltjarnarnes (IS)

(21) Appl. No.: 18/849,496

(22) PCT Filed: May 16, 2023
(86) PCT No.: PCT/US2023/067037

§ 371 Date: Sep. 21, 2024

Related U.S. Application Data
(60) Provisional application No. 63/343,213, filed on May 18, 2022.

(51) Int. Cl. B25B 23/06; B25F 3/00

(52) U.S. Cl. CPC B25B 23/06; B25F 3/00

(57) ABSTRACT

A device that positions a series of fasteners in front of a driver, includes a positioner and a coupler. The positioner is operable to locate a fastener in front of the driver, and includes a receiver, a rocker, and a roller. The receiver holds and guides a clip that holds a plurality of fasteners adjacent each other. The rocker moves the clip through the receiver such that each of the plurality of fasteners is sequentially positioned in front of a bit of the driver, ready to be driven into a material. The coupler is operable to couple the positioner with the driver, and includes a mount and a body. The mount is operable to releasably fasten the coupler with the driver. The body holds the positioner while the positioner moves relative to the body, and has a groove in which the roller travels as the positioner moves relative to the body.

### CROSS-REFERENCE TO RELATED APPLICATIONS AND INCORPORATION BY REFERENCE

This application claims priority from PCT Patent Application PCT/US23/67037 filed 16 May 2023 and titled “A DEVICE FOR POSITIONING A SERIES OF FASTENERS IN FRONT OF A DRIVER, AND RELATED METHODS AND COMPONENTS”, and U.S. Provisional Patent Application 63/343,213 filed 18 May 2022 and titled “A Device For Driving Screws, And Related Systems And Methods”. This application also incorporates by this reference the entirety of PCT Patent Application PCT/US23/67037 and U.S. Provisional Patent Application 63/343,213.

### BACKGROUND

Working a construction project can be time consuming for many different reasons. Designing and laying out the project often requires a lot of time thinking about the details of the project and how best to overcome specific issues involved with the project. Driving screws into and through a material to join two more pieces of material together can also contribute to the amount of time a construction project consumes. If the project involves building a deck or hanging drywall, the time consumed in driving all of the screws required can be substantial. Much of this time is often spent obtaining each screw to be driven, then positioning the screw on the material to be driven into the material, and then positioning the driver to drive the screw. When many screws are required for a project, the time spent obtaining and positioning each screw, and then positioning the driver to drive the screw quickly adds up.

A common way to reduce the amount of time it takes to drive each individual screw is to position a number of screws in a belt that is then fed through a screw gun specifically designed to operate with the belt of screws. In operation, each screw on the belt is sequentially positioned in front of the driver after the previous screw is driven into material. The advancement of the belt through the screw gun can be done manually or automatically. Unfortunately, though, these systems are often designed to work exclusively with the system's other components. For example, you can't typically take a belt of screws designed to work with a first screw gun and use it in a second screw gun that is different than the first one. In addition, such screw gun systems also have a receiver that holds and advances the belt of screws and that is configured to hold and advance a belt of screws having a specific size. If one wanted to drive one or more different sized screws in a material, one would have to remove the current receiver from the screw gun, and then attach a different receiver that is configured to hold and advance a belt of smaller or larger screws.

Thus, there is a need for a system that can be easily coupled to any screw gun and that can hold and advance a variety of different sized screws.

### SUMMARY

In one aspect of the invention, a device that positions a series of fasteners in front of a driver includes a positioner and a coupler. The positioner is operable to locate a fastener in front of the driver, and includes a receiver, a rocker, and a roller. The receiver holds and guides a clip that holds a plurality of fasteners adjacent each other. The rocker moves the clip through the receiver such that each of the plurality of fasteners is sequentially positioned in front of a bit of the driver, ready to be driven into a material. The coupler is operable to couple the positioner with the driver, and includes a mount and a body. The mount is operable to releasably fasten the coupler with the driver. The body holds the positioner while the positioner moves relative to the body and has a groove in which the roller travels as the positioner moves relative to the body. In operation, the positioner's roller moves along the groove of the coupler's body as the positioner moves relative to the coupler. When the positioner moves away from the coupler's mount, the roller moves toward a first end of the groove. As the roller moves toward the first end, the roller moves the rocker in a first direction, which moves the clip relative to the receiver to position one of the plurality of fasteners in front of the driver's bit.

With screws held in a clip that is positioned by movement of the positioner's rocker, any size screw may be held in the clip. Thus, the device may be used to drive a variety of screws having different sizes. In some situations, the device may be used to drive a first belt of twelve #8 screws each of which are 1.25 inches in length, and then immediately afterwards, a second belt of twelve #10 screws each of which are 1.50 inches in length may be loaded into the receiver of the positioner and subsequently driven by the driver. In other situations, the device may be used to drive a belt of twelve screws, six of which are #8 screws having a length of 1.25 inches, and the other six of which are #10 screws having a length of 1.50 inches. In addition, with the coupler's mount operable to releasably fasten the device to a screw gun, the device may be used with any conventional screw gun as well as any conventional drill.

In another aspect of the invention, a method for sequentially driving a plurality of fasteners, includes: 1) moving in a first direction a positioner of a device relative to a coupler of the device, wherein the coupler is releasably fastened to a driver; 2) engaging a bit of the driver with the first fastener, wherein the first fastener is held by a clip that is held in the positioner; 3) driving, with the bit, the first fastener into a material; 4) moving in a second direction the positioner of the device relative to the coupler; 5) moving the clip, in response to the movement of the positioner in the second direction; and 6) positioning the second fastener in front of the driver's bit.

In yet another aspect of the invention, a clip for holding a plurality of fasteners adjacent each other, includes a plurality of holders each releasably holding a fastener, and each releasably attached to an adjacent holder. Each holder includes a body, a locking rail, and a positioning rail. The body is configured such that a hole is defined between two adjacent bodies through which a fastener extends when the holder holds a fastener. The locking rail is configured to allow movement of the holder in a first direction and prevent movement of the holder in a second direction. And, the positioning rail receives input from a positioner of a device that moves the body in the first direction.

### BRIEF DESCRIPTION OF THE DRAWINGS

FIG. 1 shows a perspective view of a device that positions a series of fasteners in front of a driver, according to an embodiment of the invention.

FIG. 2 shows an exploded view of a positioner and coupler of the device shown in FIG. 1, according to an embodiment of the invention.

FIG. 3 shows a cross-sectional view of the positioner and coupler shown in FIGS. 1 and 2, according to an embodiment of the invention.

Each of FIGS. 4A and 4B shows a cross-sectional view of the positioner shown in FIGS. 1, 2 and 3, according to an embodiment of the invention.

Each of FIGS. 5A and 5B shows another cross-sectional view of the positioner shown in FIGS. 1, 2 and 3, according to an embodiment of the invention.

FIG. 6 shows a cross-sectional view of the coupler shown in FIGS. 1-2, according to an embodiment of the invention.

FIG. 7 shows a perspective view of a clip shown in FIG. 2, according to an embodiment of the invention.

FIG. 8 shows another perspective view of the clip shown in FIGS. 2 and 7, according to an embodiment of the invention.

FIG. 9 shows a perspective view of a magazine of the device shown in FIG. 1, according to an embodiment of the invention.

FIG. 10 shows a cut-away view of the magazine shown in FIGS. 1 and 9, according to an embodiment of the invention.

FIG. 11 shows a perspective view of a locator of the device shown in FIG. 1, according to an embodiment of the invention.

### DETAILED DESCRIPTION

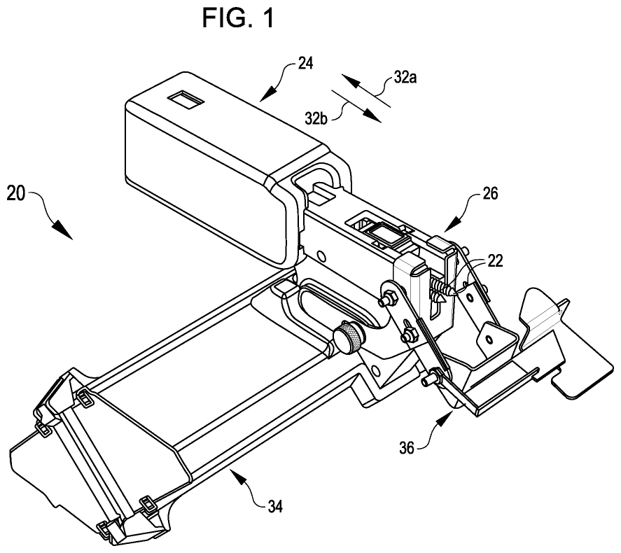

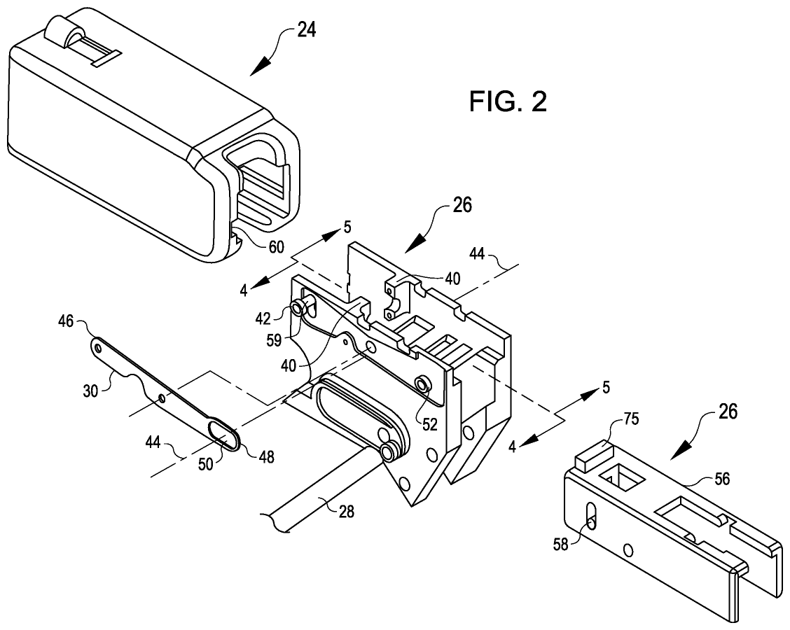

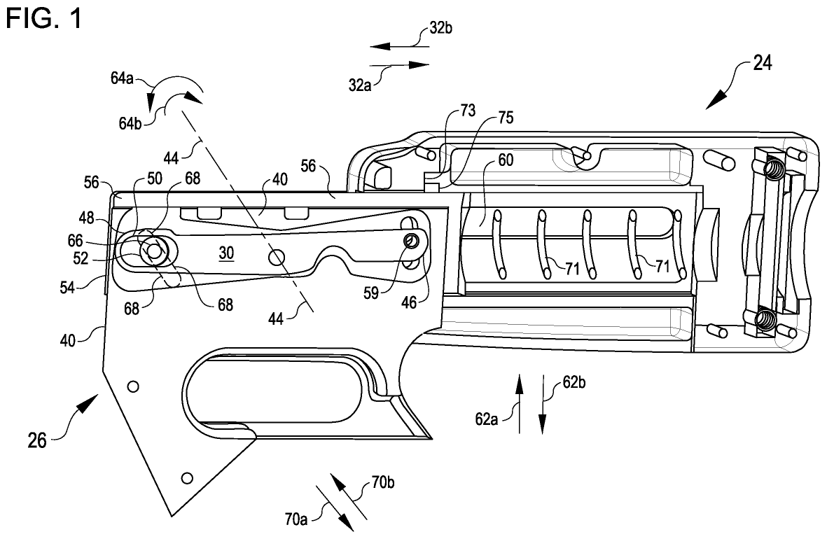

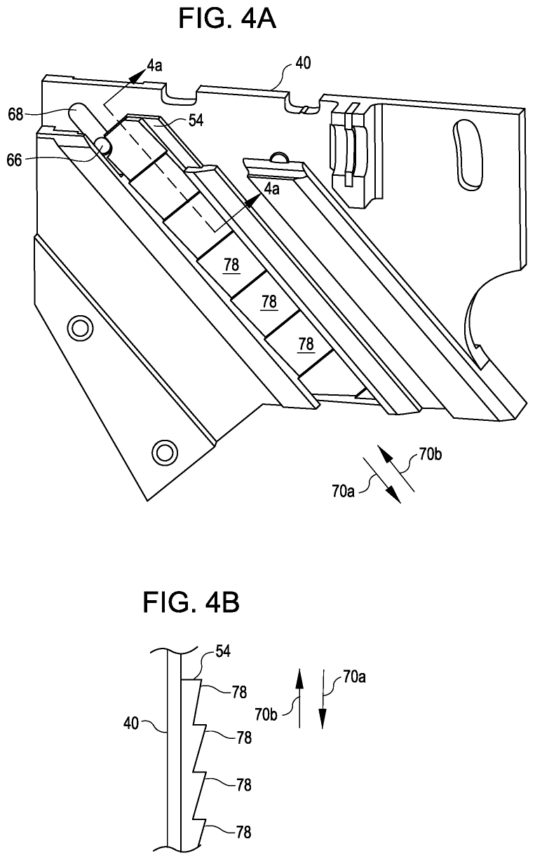

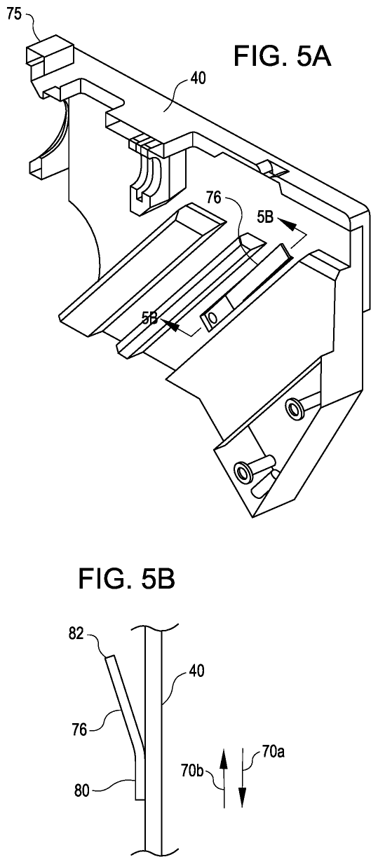

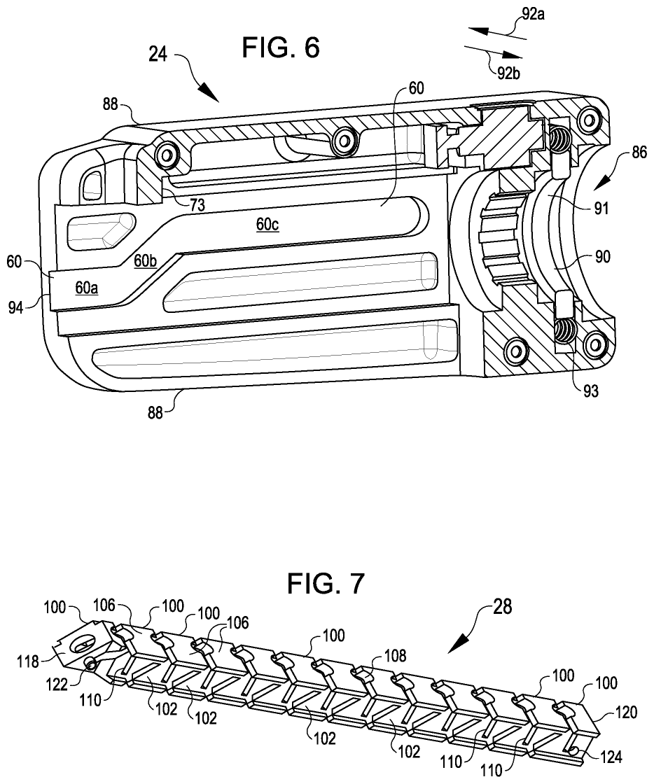

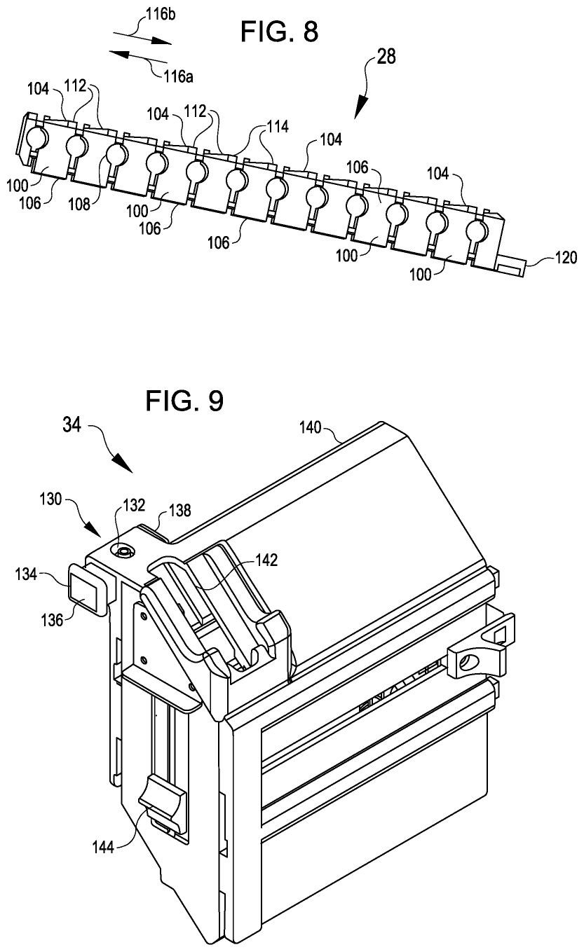

FIG. 1 shows a perspective view of a device 20 that positions a series of fasteners 22 (only two visible) in front of a driver (not shown), according to an embodiment of the invention. The device 20 includes a coupler 24 and a positioner 26. The coupler 24 (discussed in greater detail in conjunction with FIGS. 3 and 6) releasably couples the device 20 to a driver, and holds the positioner 26 in front of the driver. The driver may be any desired driver such as a conventional screw gun or a conventional drill, and the coupler 24 may be releasably coupled with the driver using any desired conventional technique. The positioner 26 (discussed in greater detail in conjunction with FIGS. 2-5B) locates the fasteners 22 (here screws) in front of the driver and positions the fastener 22 for driving. The fasteners 22 are held by a clip 28 (shown in FIG. 2 and discussed in greater detail in conjunction with FIGS. 7 and 8) that the positioner 26 advances stepwise, after the top fastener 22 is driven into material, to position the next fastener 22 for driving. To advance the clip 28, the positioner 26 includes a rocker 30 (shown in FIG. 2) that rotates about an axis of the positioner 26 in response to the positioner 26 moving relative to the coupler 24. Here, the positioner 26 moves relative to the coupler 24 in the directions indicated by the arrows labeled 32a and 32b. When the positioner 26 moves in the direction of the arrow 32a, the driver engages the fastener 22 and drives it out of the positioner 26. When the positioner 26 moves in the direction of the arrow 32b, the rocker 30 rotates in a first direction to advance the clip 28, and thus the next fastener, to the driving position in front of the driver.

With screws held in the clip 28 and the clip 28 being positioned by movement of the positioner's rocker 30, any size fastener 22 may be held in the clip 28. Thus, the device 20 may be used to drive a variety of fasteners 22 having different sizes. In some situations, the device 20 may be used to drive a first belt of twelve #8 screws each of which are 1.25 inches in length, and then immediately afterwards, a second belt of twelve #10 screws each of which are 1.50 inches in length may be loaded into the positioner and subsequently driven by the driver. In other situations, the device may be used to drive a belt of twelve screws, six of which are #8 screws having a length of 1.25 inches, and the other six of which are #10 screws having a length of 1.50 inches. In addition, with the coupler's ability to releasably couple the device 20 to any desired driver, the device 20 may be used with any conventional screw gun as well as any conventional drill.

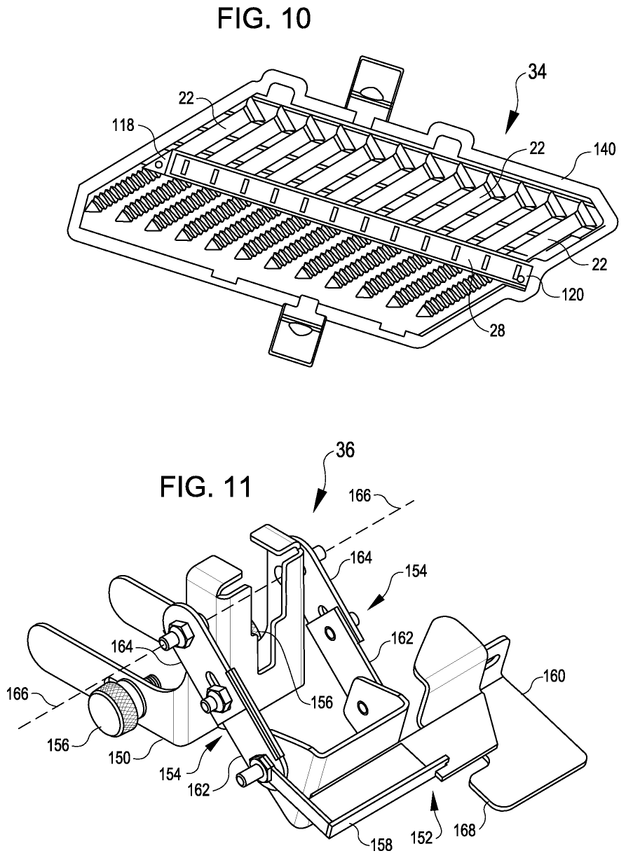

Still referring to FIG. 1, the device 20 may also include other components. For example, in this and other embodiments the device 20 includes a magazine 34 (discussed in greater detail in conjunction with FIGS. 9 and 10), and a locator 36 (discussed in greater detail in conjunction with FIG. 11). The magazine 34 holds a plurality of clips 28 and feeds each clip 28 into the positioner 26 as the previous clip 28 nears the end of its travel through the positioner 26. The locator 36 aims the positioner 26, and thus the fastener 22 that is to be driven into material (here the top screw 22), at the location on the material where the fastener is to be driven. The magazine 34 and the locator 36 are releasably coupled with the device 20 to accommodate a variety of different projects in which one may use the device 20. For example, a large-capacity magazine 34 may be releasably coupled with the device 20 when a project requires driving many fasteners, such as building a deck. A smaller-capacity magazine 34 may be releasably coupled with the device 20, or a magazine 34 may not be coupled with the device 20, when a project requires driving fewer fasteners or maneuvering the driver and device 20 above one's shoulders, such as hanging drywall. Similarly, the locator 36 may be releasably coupled with the device 20 when the project requires driving fasteners a predetermined distance from the edge of a board, such as building a deck. The locator 36 may be removed from the device 20 when the project requires driving fasteners throughout a material without regard for the fasteners distance to the edge of the material, such as hanging drywall or doubling up two sheets of plywood.

In operation, fasteners 22 are sequentially driven out of the positioner 26 and into any desired material by pushing the positioner 26, and thus the head of the fastener 22, against the driver that is coupled to the coupler 24 to engage the fastener 22 with the driver's driving bit (not shown). For example, in this and other embodiments, when the device 20 is coupled with the driver, the driving bit lies inside the coupler 24 and remains inside the coupler 24 and positioner 26 while the fastener 22 is driven out of the positioner 26. The driving bit may be configured to engage any fastener head style, such as a slotted head, a phillips head, a torx head, or a square head. In this and other embodiments, the operation of the device 20 begins with the positioner 26 located at its maximum extent out of the coupler 24 (shown in FIG. 1). In this position, the positioner 26 cannot move any further in the direction of the arrow 32b, and the fastener 22 in the positioner 26 does not contact the driver's bit. With the positioner 26 in this position, the driver and device 20 may be maneuvered as desired to locate the fastener 22 at any desired location on the material that the fastener 22 is to be driven into. Once the location on the material is determined, one locates the positioner 26 against the location on the material. Then, one pushes the driver toward the material to force the positioner 26 to move relative to the coupler 24 in the direction of the arrow 32a. After the positioner 26 moves a distance in this direction, the driver's bit contacts and engages the head of the fastener 22. Then, as the positioner 26 continues to move in the direction of the arrow 32a, the driver drives the fastener 22 out of the positioner 26 and into the material. After the positioner 26 moves a second distance in this direction, the fastener 22 becomes free of the positioner 26. This second distance may be the limit of the positioner's movement relative to the coupler 24 in the direction of the arrow 32a, or the second distance may not be the limit of the positioner's movement relative to the coupler 24. After the fastener 22 is driven out of the positioner 26, one pulls the driver away from the material, which causes the positioner 26 to move in the direction of the arrow 32b, back toward its beginning position (shown in FIG. 1). After the positioner 26 moves a distance in the direction of the arrow 32b, the coupler 24 rotates the rocker 30 which, in turn moves the clip 28 to position the next fastener 22 in front of the driver's bit.

FIG. 2 shows an exploded view of the positioner 26 and coupler 24 of the device 20 shown in FIG. 1, according to an embodiment of the invention. FIG. 3 shows a cross-sectional view of the positioner 26 and coupler 24 shown in FIGS. 1 and 2, also according to an embodiment of the invention. FIGS. 2 and 3 illustrate the motion of the positioner's rocker 30 in response to the movement of the positioner 26 relative to the coupler 34 in the directions of the arrows 32a and 32b. The motion of the clip 28 through the positioner 26 in response to the movement of the rocker 30 is discussed in greater detail in conjunction with FIGS. 4A-5B.

The positioner 26 of the device 20 includes a receiver 40, the rocker 30, and a roller 42. The receiver 40 holds and guides the clip 28 that holds a plurality of fasteners adjacent each other, while the clip 28 is moved stepwise through the positioner 26. Each of the receiver 40, rocker 30 and roller 42 may be configured as desired to provide their corresponding functions. For example, in this and other embodiments the rocker 30 is pinned to the receiver 40 such that the rocker 30 may rotate about the axis 44 when urged to do so. The rocker 30 includes a first end 46, and a second end 48 that has a slot 50. The roller 42 is mounted to the first end 46; and the slot 50 of the second end 48 captures a second roller 52. The second roller 52 is mounted to a slide 54 (discussed in greater detail in conjunction with FIGS. 4A and 4B) that is located inside the receiver 40. The positioner 26 also includes a cap 56 that covers the top of the receiver 40. When the positioner 26 is coupled with the coupler 24, the cap 56 covers the second roller 52 lying in the slot 50 to keep the second roller 52 in the slot while the rocker 30 rotates about the axis 44, but the cap 56 does not cover the roller 42. Instead, the shaft 59 of the roller 42 that mounts the roller 42 to the rocker's first end 46, extends through the slot 58, and the roller 42 lies in the groove 60 (discussed in greater detail in conjunction with FIG. 6) inside the coupler 24.

As the positioner 26 moves in the directions of the arrows 32a and 32b, the groove 60 directs the movement of the roller 42 in the directions that are perpendicular to the directions of the arrows 32a and 32b. More specifically, as the positioner 26 moves in the direction of the arrow 32a, the groove 60 initially keeps the roller 42 from moving perpendicular to the directions of the arrows 32a and 32b. Then, after the positioner 26 travels a distance, the groove 60 forces the roller 42 up in the direction of the arrow 62a. This causes the rocker 30 to rotate in a first direction (arrow 64a), and thus, the rocker's second end 48 to move in the direction indicated by the arrow 62b. Because the second roller 52 is captured in the slot 50 of the second end 48, the second roller 52 also moves; but because the shaft 66 of the second roller 52 extends through the slot 68 in the receiver 40 to reach the slide 54 that the second roller 52 is mounted to, the movement of the second roller 52 is confined to the direction of the arrow 70a. This motion moves the slide 54 in the direction of the arrow 70a in preparation for engaging and advancing the clip 28 in the receiver 40. After the rocker 30 has rotated enough to move the slide 54 to the desired location where it engages the clip 28, the groove 60 no longer forces the roller 42 to move in either direction of the arrows 62a and 62b, and thus prevents the slide 54 from advancing the clip 28. During this period of the roller's travel in the groove 60, the driver drives the fastener 22 out of the receiver 40. Then, as the positioner 26 moves in the direction of the arrow 32b to return to its starting position, the groove 60 forces the roller 42 down in the direction of the arrow 62b after the roller travels a distance. This causes the rocker 30 to rotate in a second direction (arrow 64b), and thus, the rocker's second end 48 to move in the direction indicated by the arrow 62a. This motion moves the slide 54 in the direction of the arrow 70b which advances the clip 28 in the receiver 40. After the rocker 30 has rotated enough to move the slide 54 to the desired location where the fastener 22 is positioned in front of the driver's bit, ready to be driven out of the receiver 40, the groove 60 no longer forces the roller 42 to move in either direction of the arrows 62b and 62a, and thus stops the slide 54 from advancing the clip 28. Now, the positioner 26 is ready to be moved again in the direction of the arrow 32a to drive the new fastener 22 out of the receiver 40.

As discussed in greater detail in conjunction with FIG. 6, in this and other embodiments the coupler 34 includes a spring 71 that urges the positioner 26 to extend out beyond the coupler 34. To keep the positioner 26 from being ejected from the coupler 34, the coupler 34 includes a stop 73 that contacts the boss 75.

Each of FIGS. 4A-5B shows a cross-sectional view of the positioner shown in FIGS. 1, 2 and 3, according to an embodiment of the invention. FIGS. 4A-5B illustrate the motion of the clip 28 through the positioner 26 in response to the movement of the rocker 30.

The receiver 40 may be configured as desired to receive and hold a clip 28 of fasteners 22 (FIG. 1) while the clip 28 is moved through the receiver 40. For example, in this and other embodiments the receiver 40 includes the slide 54 (FIGS. 4A and 4B) and a spring 76 (FIGS. 5A and 5B) that holds the clip 28 against the slide 54 while the slide moves the clip 28 through the receiver 40. The slide 54 and spring 28 may be configured as desired to provide their corresponding functions. For example, in this and other embodiments, the slide 54 and spring 28 work together to allow the clip 28 to move through the receiver 40 in the direction of the arrow 70b, but prevent the clip 28 from moving through the receiver 40 in the direction of the arrow 70a. More specifically, the slide 54 includes a tooth 78 that has saw-tooth profile (shown in FIG. 4B), and the spring 76 is a leaf spring (shown in FIG. 5B). Here, the slide 54 includes seven teeth 78 that are arranged such that they form a rack or series of protrusions that engage a positioning rail of the clip 28 (discussed in greater detail in conjunction with FIGS. 7 and 8). The saw-tooth profile of each of the teeth 78 is configured such that as the slide 54 moves in the direction of the arrow 70a, each of the teeth 78 contacts the clip 28 but slips over the clip 28, and thus does not move the clip 28 in the direction of the arrow 70a. This slipping or sliding motion over the clip 28 is helped by the spring 76 engaging the clip 28 and preventing the clip's movement in the direction of the arrow 70a. The spring 76 includes a first end 80 that is mounted to the receiver 40, and a second end that extends away from the receiver 40 toward the slide 54 located on the other half of the receiver 40. The spring 76 is made of a material, such as steel or any other metal, that elastically deforms in response to a force pushing the second end 82 toward the receiver half that the first end 80 is mounted to. In this manner, the spring 76 resists such a force, and in so doing urges the clip 28 against the slide 54. The second end 82 is also configured to be received by a locking rail of the clip 28 (also discussed in greater detail in conjunction with FIGS. 7 and 8). When the second end 82 is received by the locking rail, the spring 76 prevents the clip 28 from moving in the direction of the arrow 70a. But, because the second end 82 is located downstream (in the direction of the arrow 70b) from the first end 80, when the tooth 78 of the slide 54 moves the clip 28 in the direction of the arrow 70b, the spring 76 slips or slides over the locking rail of the clip 28.

FIG. 6 shows a cross-sectional view of the coupler 24 shown in FIGS. 1-2, according to an embodiment of the invention. The coupler 24 releasably couples the device 20 to a driver, and holds the positioner 26 in front of the driver.

The coupler 24 may be configured as desired to accomplish this function. For example, in this and other embodiments the coupler 24 includes a mount 86, and a body 88 that includes the groove 60. The mount 86 is configured to releasably couple any desired driver with the coupler's body 88. More specifically, the mount 86 includes a collar 90 that is split in half. One half 91 of the collar 90 is movable in the directions indicated by the arrows 92a and 92b, while the other half of the collar (not shown) is fixed to the body 88. A spring 93 is disposed between the half 91 of the collar 90 and the body 88 so that the collar half 91 is urged against the fixed half of the collar. In this manner, the collar 90 is urged against the portion of the driver that is just aft of the driver's component that holds the driving bit and that rotates to rotate the driving bit, regardless of the size of the driver's component. With this configuration, the coupler 24, and thus the device 20, may be used with a variety of different sized drivers.

The groove 60 may be configured as desired to control the movement of the rocker 30 and thus the stepwise movement of the clip 28 through the receiver 40 of the positioner 26. For example, in this and other embodiments the groove 60 has length that includes three different sections 60a, 60b and 60c, each extending a corresponding distance, and a cross-section that does not change along any of the three sections. More specifically, the cross-section of the groove 60 is a square channel, and the groove 60 has a first end 94 where the first section 60a begins. The section 60a then extends until the groove 60 changes direction, at which point section 60b begins. The section 60b, in turn, extends until the groove 60 changes direction again, at which point the section 60c starts and extends to the end of the groove 60. The specific lengths of each of these sections 60a, 60b, and 60c, and the arrangement of the sections of the groove 60 that each corresponds to, dictate when and to what extent the rocker 30 rotates about the axis 44 (FIGS. 2 and 3), and thus, the timing and extent of each of the clip's stepped advancement through the receiver 40 of the positioner 26. The relative, perpendicular distance between the sections 60a and 60c establish the total distance that the slide 54 and thus the clip 28 moves in the positioner's receiver 40. The length of the section 60b determines how quickly the slide 54 and thus the clip 28 moves through an individual step in the clip's advancement. And the location of the section 60b between the sections 60a and 60c—i.e., the length of the section 60a before the section 60b begins—determines when the slide 54, and thus the clip 28, moves in the cycle of sequentially driving the fasteners 22 (FIG. 1).

Other embodiments are possible. For example, the groove 60 may include more than the three sections 60a, 60b, and 60c, each different from its adjacent section. More specifically, the groove 60 may include a fourth section located between the sections 60b and 60c that has a shallower slope than the section 60b has. This may be desirable to postpone the completion of the next fastener's advancement into the driving position to reduce the possibility of a clip 28 getting jammed in the positioner 26. Postponing the completion of the next fastener's advancement, however, is limited by the length of the screw being driven. If the fastener 22 is long, then the completion of the next fastener's advancement must be closer to the end 94 of the groove 60 than if the length of the fastener 22 is short.

FIG. 7 shows a perspective view of the clip 28 shown in FIG. 2, according to an embodiment of the invention. FIG. 8 shows another perspective view of the clip 28 shown in FIGS. 2 and 7, according to an embodiment of the invention. The clip 28 holds the fasteners 22 (FIG. 1) while the positioner 26 advances the fasteners 22 stepwise through the positioner's receiver 40, and is the component that the slide 54 and spring 76 contact to advance the fasteners 22.

The clip 28 may be configured as desired to accomplish this function. For example, in this and other embodiments the clip 28 includes a plurality of holders 100 (only six labeled for clarity), each releasably holding a fastener 22, and each releasably attached to an adjacent holder 100. Each holder 100 includes a locking rail 102 (only four labeled for clarity), a positioning rail 104 (only four labeled for clarity), and a body 106 (only six labeled for clarity). Each body 106 configured such that a hole 108 (only two labeled for clarity) is defined between two adjacent bodies 106, that is sized to hold the fastener 22. Each of the bodies 106 is also configured to break away from its adjacent body 106 as the fastener 22 located between the two bodies 106 is driven out of the clip 28. The locking rail 102 includes a groove 110 (only three labeled for clarity) that is sized and configured to receive the second end 82 (FIG. 5B) of the spring 76 (FIG. 5B) when the groove 110 is positioned adjacent the second end 82. The positioning rail 104 includes a tooth 112 (only four labeled for clarity) that is sized and configured to contact the tooth 78 (FIGS. 4A and 4B) and engage the tooth 78 the tooth 78 is positioned such that the edge 114 slides between two adjacent teeth 78 and contacts a similar edge of one of the teeth 78. In this manner, the slide 54 (FIGS. 4A and 4B) moves the clip 28 when the slide 54 moves in the direction of the arrow 116a, and simply slides over the tooth 112 when the slide 54 moves in the direction of the arrow 116b.

Each clip 28 may be loaded in the receiver 40 of the positioner 26 in any desired manner. For example, in this and other embodiments each clip 28 includes a head 118, and a tail 120. The head 118 includes a post 122; and the tail includes a hole 124. The hole 124 is sized and configured to receive and hold the post 122 of the previous clip 28. When the previous clip 28 reaches a position in the positioner's receiver 40 and additional clips 28 are loaded into the magazine 34 (FIGS. 1, 9 and 10), the magazine 34 urges the following clip 28 into alignment with the previous clip 28 by inserting the post 122 into the hole 124 of the previous clip 28. Then, as the slide 54 moves the previous clip 28 through the positioner's receiver 40, the previous clip 28 pulls the following clip 28 into the receiver 40 until the slide 54 can contact and engage its positioning rail.

FIG. 9 shows a perspective view of the magazine 34 of the device 20 shown in FIG. 1, according to an embodiment of the invention. FIG. 10 shows a cut-away view of the magazine 34 shown in FIGS. 1 and 9, according to an embodiment of the invention.

The magazine 34 holds a plurality of clips 28 and feeds each clip 28 into the positioner 26 when the positioner 26 is ready to receive each one, and may configured as desired to accomplish this. For example, in this and other embodiments the magazine 34 includes a mount 130 to releasably couple the magazine 34 with the receiver 40 of the positioner 26. The mount 130 includes a receptacle 132 that receives a post (not shown) of the receiver 40, and catch 134 that releasably locks the post in the receptacle 132 by moving the end 136 of the catch 134 toward the receptacle 132. To release the post from the receptacle 132, and thus the magazine 34 from the positioner 26, one moves the end 138 toward the receptacle 132. The magazine 34 also includes a body 140 that houses the clips 28 of fasteners 22 (FIG. 10), an exit 142 through which each of the clips 28 in the body 140 pass through to enter the positioner's receiver 40, and a spring (not shown) disposed inside the body 140 to urge the clips 28 inside the body 140 toward the exit 142. As previously described each clip 28 includes a head 118 and tail 120 (FIG. 10) that couple together to pull a clip 28 out through the exit 142 and into the positioner's receiver 40. The first clip 28 to leave the magazine 34, however does not have a previous clip 28 to pull it out of the magazine 34. Instead, the slide 144 is used to push the first clip 28 out of the magazine 34 through the exit 142 and into the positioner's receiver 40 by engaging the positioning rail 104 of the clip 28 in a similar way as the positioner's slide 54 (FIGS. 4A and 4B) engages and moves the clip 28 through the positioner's receiver 40.

FIG. 11 shows a perspective view of the locator 36 of the device 20 shown in FIG. 1, according to an embodiment of the invention. The locator 36 aims the positioner 26, and thus the fastener 22 that is to be driven into material, at the location on the material where the fastener 22 is to be driven into.

The locater 36 may be configured as desired to accomplish this function. For example, in this and other embodiments the locater 36 includes a mount 150 that releasably couples the locator 36 with the positioner 26, a tongue 152 that contacts the material into which the fastener 22 is to be driven, and an arm 154 that locates the region of the material that will receive the fastener 22 once the tongue 152 contacts the material. More specifically, the mount includes two screws 156 that engage the positioner's receiver 40 to couple the locator 36 with the positioner 26. The tongue 152 includes a first frame 158 that locates the edge of two boards, such as deck boards, that are adjacent each other, and a second frame 160 that locates the edge of a support beam, such as a joist, that the two boards are fastened to. The second frame 160 ensures that the fastener 22 driven into one of the boards will also be driven into the support beam underneath the board to fasten the board to the support beam. The arm 154 locates the region on the board where the fastener 22 will be driven. This region is usually desired to be halfway between the sides of the board, but the desired region does not have to be. So, to provide the ability to locate the desired region anywhere on the board, the arm 154 is adjustable by releasably securing a first portion 162 of the arm with a second portion 164. This adjustment allows one to change the distance of the fastener 22 in the positioner 26 that is ready to be driven to the first frame 158 that locates the edge of the board. The arm 154 is also releasably coupled with the mount 150 such that the arm 154 may rotate about the axis 166. In this manner, the locator 36 may be used to locate two different regions where a fastener is to be driven. Each of these regions may be on a single board or they may be on a respective one of two boards, such when the two different boards are being fastened to a support beam to construct a deck. The second frame 160 locates the edge of a support beam by contacting the side of the beam with the edge 168. And similar to the arm 154, the tongue's second frame 160 may be moved relative to the first frame 158 to accommodate wider or narrower support beams by moving the edge 168 closer to or farther away from the first frame 158.

The preceding discussion is presented to enable a person skilled in the art to make and use the invention. Various modifications to the embodiments will be readily apparent to those skilled in the art, and the generic principles herein may be applied to other embodiments and applications without departing from the spirit and scope of the present invention. Thus, the present invention is not intended to be limited to the embodiments shown, but is to be accorded the widest scope consistent with the principles and features disclosed herein.

1. A device that positions a series of fasteners in front of a driver, the device comprising:
a positioner operable to locate a fastener in front of a driver, the positioner including:
a receiver that holds and guides a clip that holds a plurality of fasteners adjacent each other,
a rocker that moves the clip through the receiver such that each of the plurality of fasteners is sequentially positioned in front of a bit of the driver, ready to be driven into a material, and
a roller;
a coupler for coupling the positioner with the driver, the coupler including:
a mount operable to releasably fasten the coupler with the driver,
a body that holds the positioner while the positioner moves relative to the body, the body having a groove in which the roller travels as the positioner moves relative to the body; and
wherein as the positioner moves relative to the body away from the coupler's mount, the roller moves along the groove toward a first end of the groove, and as the roller moves toward the first end, the roller moves the rocker in a first direction, and as the rocker moves in the first direction, the clip moves relative to the receiver to position one of the plurality of fasteners in front of the driver's bit.

2. The device of claim 1 wherein the roller is mounted to an end of the rocker.

3. The device of claim 1 wherein the rocker rotates about a pivot axis to move the clip through the receiver.

4. The device of claim 1 wherein the receiver includes a slide that moves the clip through the receiver when the rocker moves in the first direction.

5. The device of claim 1 wherein the receiver includes:
a slide that moves the clip through the receiver when the rocker moves in the first direction, and
a spring that holds the clip against the slide while the slide moves the clip through the receiver.

6. The device of claim 1 wherein the receiver includes:
a slide that moves the clip through the receiver when the rocker moves in the first direction, the slide having a tooth that engages the clip such that the tooth moves the clip through the receiver when the rocker moves in the first direction, and moves relative to the clip when the rocker moves in a direction opposite the first direction, and
a spring that holds the clip against the slide while the slide moves the clip through the receiver.

7. The device of claim 1 wherein the receiver includes a slide that moves the clip through the receiver when the rocker moves in the first direction, the slide having a second roller that lies in a slot of the rocker and that travels in the slot to transmit the movement of the rocker to the slide.

8. The device of claim 1 wherein:
the receiver includes a slide that moves the clip through the receiver when the rocker moves in the first direction, and
the clip includes a tooth configured to engage the slide when the slide moves in the first direction, and to allow the slide to slip past the tooth when the slide moves in a direction opposite the first direction.

9. The device of claim 1 wherein the positioner moves relative to the body along a longitudinal axis of the body.

10. A system for sequentially driving a plurality of fasteners, the system comprising:
a clip that holds a plurality of fasteners adjacent each other; and
a device that sequentially positions each of the plurality of fasteners in front of a driver, the device comprising:
a positioner operable to locate a fastener in front of the driver, the positioner including:
a receiver that holds and guides the clip,
a rocker that moves the clip through the receiver such that each of the plurality of fasteners is sequentially positioned in front of a bit of the driver, ready to be driven into a material, and
a roller;
a coupler for coupling the positioner with the driver, the coupler including:
a mount operable to releasably fasten the coupler with the driver,
a body that holds the positioner while the positioner moves relative to the body, the body having a groove in which the roller travels as the positioner moves relative to the body; and
wherein as the positioner moves relative to the body away from the coupler's mount, the roller moves along the groove toward a first end of the groove, and as the roller moves toward the groove's first end, the roller moves the rocker in a first direction, and as the rocker moves in the first direction, the clip moves relative to the receiver to position one of the plurality of fasteners in front of the driver's bit.

11. The system of claim 10 wherein the system is releasably mounted to a screw gun.

12. The system of claim 10 further comprising a locater operable to position the fasteners toward a region of a material.

13. The system of claim 12 wherein the locator is adjustable.

14. The system of claim 10 further comprising a magazine releasably coupled with the positioner and operable to hold a plurality of clips.

15.-22. (canceled)

23. A method for sequentially driving a plurality of fasteners, the method comprising:
moving in a first direction a positioner of a device relative to a coupler of the device, wherein the coupler is releasably fastened to a driver;
engaging a bit of the driver with the first fastener, wherein the first fastener is held by a clip that is held in the positioner;
driving, with the bit, the first fastener into a material;
moving in a second direction the positioner of the device relative to the coupler;
moving the clip, in response to the movement of the positioner in the second direction; and
positioning the second fastener in front of the driver's bit.

24. The method of claim 23 wherein the first direction is toward the driver.

25. The method of claim 23 wherein the second direction is away from the driver.

26. The method of claim 23 wherein moving the second clip includes sliding the clip in the positioner.

27. The method of claim 23 wherein positioning the second fastener in front of the driver's bit includes rotating a rocker of the positioner.

28. The method of claim 23 wherein positioning the second fastener in front of the driver's bit includes rotating a rocker of the positioner by moving a roller of the positioner along a groove of the coupler.

29. The method of claim 23 wherein driving the first fastener into the material includes breaking a holder of the clip away from an adjacent holder of the clip.

30. The method of claim 23 further comprising engaging the driver's bit with the second fastener, wherein the second fastener is held by the clip.

31. The method of claim 23 further comprising a tongue of the clip engaging a hole of a subsequent clip to pull the subsequent clip into the device's positioner.
